(19) United States
(12) Patent Application Publication
(10) Pub. No.: US 2007/0053821 A1
(43) Pub. Date: Mar. 8, 2007

(54) Production of layered double hydroxides

(76) Inventors: Gavin Patrick Gillman, Queensland (GB); David Andrew McCallum, Victoria (AU)

Correspondence Address: FOLEY AND LARDNER LLP;SUITE 500, 3000 K STREET NW, WASHINGTON, DC, 20007, US

(21) Appl. No.: 10/553,522

(22) PCT Filed: Apr. 13, 2004
(86) PCT No.: PCT/AU04/00481

§ 371 Date: Oct. 23, 2006

(30) Foreign Application Priority Data
Apr. 15, 2003 (AU) 2003901788

(51) Int. Cl. C01C 1/18; C01F 7/00

(52) U.S. Cl. 423/396; 423/600

(57) ABSTRACT

A method for the manufacture of ammonium nitrate and LDH containing nitrate as an interlayer anion, the method including the steps of: (1) providing a source of nitric acid (2) providing a source of ammonia; (3) reacting ammonia with nitric acid to produce ammonium nitrate; (4) preparing a nitrate containing a first metal by reacting a compound containing the first metal with nitric acid or ammonium nitrate; (5) either. (a) preparing a nitrate containing a second metal by: (i) contacting a compound containing the second metal with nitric acid; or (ii) contacting a compound containing the second metal with ammonium nitrate; or (b) providing a compound containing the second metal; and (6) mixing the nitrate containing the first metal from step (4) with the nitrate containing the second metal or the compound containing the second metal from step (5) and ammonium hydroxide to form the LDH containing nitrate as an interlayer anion and ammonium nitrate. The method can be integrated with existing ammonium nitrate plants.

### FIELD OF THE INVENTION

The present invention relates to a method and a plant for producing layered double hydroxide compounds. The present invention is particularly suitable for producing hydrotalcites, especially hydrotalcite in which the interlayer anion is nitrate.

### BACKGROUND OF THE INVENTION

Layered double hydroxides (hereinafter referred to as “LDH compounds”) are mixed hydroxides of divalent and tri-valent metals having an excess of positive charge that is balanced by interlayer anions. They can be represented by the general formula (1).
M₁₋ₓ²⁺Mₓ³⁺(OH)₂A_{x/n}ⁿ⁻yH₂O (1)

where M²⁺ and M³⁺ are di- and tri-valent metal ions respectively and Aⁿ⁻ is the interlayer anion of valance n. The x value represents the proportion of trivalent metal to the total amount of metal ion present and y denotes variable amounts of interlayer water.

Common forms of LDH comprise Mg²⁺ and Al³⁺ known as hydrotalcites) and Me²⁺ and Fe³⁺ known as pyroaurites), but other cations including Ni, Zn, Mn, Ca, Cr, and La are known. The amount of surface positive charge generated is dependent upon the mole ratio of the metal ions in the lattice structure, and the conditions of preparation as they affect crystal formation. LDH compounds are well known in industry, being used as catalysts in organic conversion reaction, PVC stabilisers, flame retardants, medicinal antacids, and in wastewater treatment.

The typical formation of hydrotalcite (the most commonly synthesised LDH with carbonate as the principal “exchangeable” anion) may be most simply described by the following reaction:
6MgCl₂+2AlCl₃+16NaOH+H₂CO₃→Mg₆Al₂(OH)₁₆CO₃.nH₂O+2HCl+16NaCl

Typically, ratios of divalent to trivalent cations in hydrotalcites vary from 2:1 to 3:1. Other synthetic pathways to form hydrotalcite (and other LDH's) include synthesis from Mg(OH)₂ (brucite) and MgO (calcined magnesia) via neutralisation of acidic solutions.

A range of metals of widely varying concentrations may also be simultaneously coprecipitated, hence forming a polymetallic LDH. Layered double hydroxides may also be synthesised from industrial waste materials by the reaction of bauxite residue derived from alumina extraction (red mud) with seawater, or by the reaction of lime with fly ash derived from fossil fuel (eg. coal fired power stations).

Within the LDH structure there are octahedral metal hydroxide sheets that carry a net positive charge due to limited substitution of trivalent for divalent cations as described above. As a consequence, it is possible to substitute a wide range of inorganic or organic anions into the LDH structure. These anions are often referred to as “interlayer anions” as they fit between the layers of hydroxide material. The selectivity of hydrotalcites to various interlayer anions differs with a selectivity series in the approximate order CO₃²⁻>HPO₄²⁻>>SO₄²⁻, OH^{->F}⁻>Cl⁻>NO₃⁻. The anions at the top of the order are more tightly held by the hydrotalcite.

In our co-pending International Patent Application No. PCT/AU01/00026, filed 12 Jan. 2001, the use of LDH's in soil ameliorates and slow release fertilisers is described. The entire contents of International patent application no. PCT/AU01/00026 are incorporated herein by cross-reference.

In order to produce a fertiliser incorporating LDH's in accordance with the teachings of International patent application no. PCT/AU01/00026, the LDH's are contacted with one or more nutrient anions, such as nitrate, phosphate, sulphate and/or silicates. This results in the nutrient anions undergoing ion exchange with the interlayer ions of the LDH's and the nutrient anions are “taken up” by the IDH's. Subsequent use of the thus-loaded LDH's can see the nutrient anions being re-exchanged after the thus-loaded LDH's are supplied to the soil to thereby supply the nutrient anions to the soil.

### SUMMARY OF THE INVENTION

In a first aspect, the present invention provides a method for the manufacture of ammonium nitrate and LDH containing nitrate as an interlayer anion, the method comprising the steps of:
(1) providing a source of nitric acid
(2) providing a source of ammonia;
(3) reacting ammonia with nitric acid to produce ammonium nitrate;
(4) preparing a nitrate containing a first metal by reacting a compound containing the first metal with nitric acid or ammonium nitrate, or providing a compound containing the first metal;
(5) either:
   (a) preparing a nitrate containing a second metal by:
      (i) contacting a compound containing the second metal with nitric acid; or
      (ii) contacting a compound containing the second metal with ammonium nitrate; or
   (b) providing a compound containing the second metal;
(6) mixing the nitrate containing the first metal from step (4) with the nitrate containing the second metal or the compound containing the second metal from step (5) and ammonium hydroxide to form the LDH containing nitrate as an interlayer anion and ammonium nitrate.

Preferably, the process further comprises:
(7) recovering the LDH and the ammonium nitrate from step (6).

In one embodiment, the source of nitric acid may comprise a nitric acid plant. Alternatively, the source of nitric acid may be a nitric acid storage facility.

The source of ammonia is preferably an ammonium plant for the production of ammonia. The ammonia plant is suitably a plant for producing ammonia using the Haber process.

Where the method includes providing a compound containing the second metal in step 5(b), the compound containing the second metal is preferably an hydroxide of the second metal.

The first metal is a divalent metal and the second metal is a trivalent metal. Divalent metals include Mg, Fe, Zn, Co, Ni, Ca, Mn and trivalent metals include Al, Fe, Cr, La. It will be appreciated that this list is not exhaustive and other divalent and trivalent metals fall within the scope of the present invention.

Preferably, the LDH material is hydrotalcite in which the first metal is magnesium and the second metal is aluminium. In this embodiment, it is especially preferred that magnesium nitrate is mixed with a nitrate or hydroxide containing aluminium and ammonium hydroxide to form hydrotalcite having nitrate as an interlayer anion and ammonium nitrate. The nitrate or hydroxide is preferably aluminium nitrate or sodium aluminate (Na Al(OH)₄).

Even more preferably, the method produces hydrotalcite by one of two possible paths:
(a) mixing magnesium nitrate with sodium aluminate and ammonium hydroxide to form hydrotalcite having nitrate as an interlayer anion, ammonium nitrate and sodium nitrate, as shown in Formula (2):
   2 Mg(NO₃)₂+Na Al(OH)₄+2NH₄ OH→Mg₂ Al(OH)₆ NO₃+2 NH₄ NO₃+Na NO₃ (2)
(b) Mixing magnesium nitrate with aluminium nitrate and ammonium hydroxide to form hydrotalcite having nitrate as an interlayer ion and ammonium nitrate, or shown in Formula (3).
   2 Mg(NO₃)₂+Al(NO₃)₃+6NH₄ OH→Mg₂ Al(OH)₆ NO₃+6NH₄ NO₃ (3)

The above synthesis routes are particularly preferred because they result in the production of a hydrotalcite having nitrates as interlayer anions. This product may be used directly as a fertiliser because the nitrate ion can be transferred to the soil when the hydrotalcite is mixed with soil, thereby supplying a nutrient anion to the soil. The hydrotalcite containing nitrate as an interlayer anion can also be ion exchanged such that phosphate and/or sulphate anions become interlayer anions if it is desired to transfer one or both of those anions to the soil. Such ion exchange can be suitably achieved, for example, by contacting the hydrotalcite containing nitrate as an interlayer anion with a solution containing ammonium phosphate and/or ammonium sulphate. It will also be understood that the LDH product may be used in a number of other applications and that it should not be considered to be limited to use as a fertiliser.

As a further advantage of the preferred embodiments of the first aspect of the present invention, ammonium nitrate is also produced. Ammonium nitrate can be used in the manufacture of explosives and fertilisers and is a potentially valuable product. In some embodiments, other valuable by-products may also be produced, such as sodium nitrate when the reaction as given in formula (2) takes place.

In a preferred embodiment of the first aspect of the present invention, the source of nitric acid and the source of ammonia are components of a plant for producing ammonium nitrate. Ammonium nitrate is widely used in the production of fertilisers and explosives. As such, annual production worldwide of ammonium nitrate is large, with a commensurate abundance of ammonium nitrate plants. The method of this embodiment of the first aspect of present invention is preferably embodied as an addition to, or a retrofit to, an existing ammonium nitrate plant. By embodying the method of the first aspect of the invention in this way, it is possible to utilise ammonia and nitric acid used or manufactured in the ammonium nitrate plant as feed materials for the part of the plant that produces the LDH's.

With these comments in mind, it is apparent that steps (1), (2) and (3) of a preferred embodiment of the first aspect of the invention may comprise the process steps of an existing ammonium nitrate plant. The source of nitric acid may comprise a storage facility for storing nitric acid produced off-site or it may comprise a nitric acid production plant for producing nitric acid from suitable starting materials. Similarly, the source of ammonia may be an ammonium storage facility for storing ammonia produced off-site or it may comprise an ammonia plant for producing ammonia from suitable starting materials.

Step (3) may comprise any suitable method for producing ammonium nitrate by reacting ammonia and nitric acid. Such methods are well known to those of skill in the art and need not be described further.

In one embodiment, step (4) requires that a nitrate containing a first metal be prepared. The first metal is preferably magnesium. If the second metal is aluminium, the LDH that is formed is hydrotalcite containing nitrate as interlayer anions.

The step of forming a nitrate containing magnesium may involve contacting a magnesium compound with nitric acid to form a nitrate containing magnesium. The magnesium compound may be magnesite (MgCO₃), a readily-available inexpensive compound. Magnesium oxide (MgO) may also be used, with calcined magnesia or reactive magnesia being suitable. Magnesium hydroxide (Mg(OH)₂) may also be used.

It will be understood that the term “a nitrate containing a first metal” encompasses a nitrate that may be in the form of a solid or in dissolved or melted form, in which case the nitrate compound is in a dissociated form. Preferably, the nitrate containing a first metal is in the form of an aqueous solution.

The nitrate containing the first metal may be formed in the reactor for producing the LDH, or it may be formed in a separate reactor, with the thus-formed nitrate containing the first metal being added to the reactor for producing the LDH.

Step (5) of the method of the first aspect of the invention may comprise (a) reacting a compound containing a second metal with nitric acid or ammonium nitrate to form a nitrate of the second metal or (b) providing a compound containing the second metal. The second metal is preferably aluminium. In step 5(b), an hydroxide containing the second metal is the preferred compound.

Step (5)(b) may preferably comprise supplying sodium aluminate (Na Al(OH)₄). The sodium aluminate may be supplied as part of a pregnant Bayer liquid from a bauxite digestion plant. The step of providing a compound of the second metal may comprise providing bauxite.

It will be appreciated that the nitrate containing the second metal may be in the form of a solid or in a dissolved or melted state, in which case the nitrate compound will be in a dissociated form. Preferably, the nitrate containing the second metal is in the form of an aqueous solution.

The nitrate containing the second metal may be formed in the reactor for producing the LDH or it may be formed in a separate reactor with the thus-formed nitrate containing the second metal being added to the reactor for producing the LDH.

Where one or both of the steps of forming the nitrate containing the first metal and forming the nitrate containing the second metal take place in the reactor for producing the LDH, it will be appreciated that a compound containing the first metal and/or a compound containing the second metal may be provided to the reactor for producing the LDH.

The hydroxide containing the second metal may also contain one or more other metals. It may also be in solid form, a dissolved state or a molten state. Preferably, it is in the form of an aqueous solution.

Step (6) of the method of the first aspect of the present invention involves a reaction to form the LDH containing nitrate as the interlayer anion. The LDH thus formed is preferably hydrotalcite. The reaction preferably occurs by mixing aqueous solutions containing the first metal and the second metal under vigorous stirring whilst adding ammonium hydroxide at a rate sufficient to maintain the pH at about 9.5. Alternatively, the aqueous solutions containing the first metal and the second metal can be mixed in appropriate portions and then added to an ammonium hydroxide solution until the pH falls to about 9.5. The reaction may take place at ambient temperature and atmospheric pressure. Upon mixing, the LDH immediately forms. If a more crystalline product, or a product having larger particle size, is desired, the resulting slurry can be “aged” by, for example, holding at elevated temperature, eg at 80° C. for 8 hours, or the slurry can be hydrothermally treated at elevated temperature and pressure.

In addition to producing LDH's, ammonium nitrate is also formed in step (6). When the method of the second aspect of the invention forms part of an ammonium nitrate plant, the “by-product” ammonium nitrate from step (6) can be recovered as a valuable product for sale to consumers. This, of course, improves the economics of the process.

In another embodiment, the process of the second aspect of the present invention preferably comprises preparing the nitrate containing the first metal in step (4) by reacting the compound containing the first metal with ammonium nitrate. In this embodiment, the process may comprise the further step of:
(8) recycling the ammonium nitrate from step (6) to step (4).

The ammonium nitrate that is recycled from step (6) to step (4) may pass to an intermediate storage before being recycled to step (4).

In addition to producing LDH's, ammonium nitrate is also formed in step (6). In another embodiment, this ammonium nitrate can then be reacted with additional first metal compound (e.g. MgO) in step (4) to produce more first metal nitrate for LDH production or it can be recovered for sale as ammonium nitrate product. Preferably, ammonia is also produced in step (4), and this can be recycled for LDH production in step (6). This, of course, improves the economics of the process. Alternatively, the ammonia produced in step (4) can be recycled to the source of ammonia.

In another embodiment of the present invention, step (5) may involve producing a nitrate containing the second metal by contacting a compound containing the second metal with ammonium nitrate. This allows the possibility of using some of the ammonium nitrate produced in step (6) to be returned to step (5). Indeed, in this embodiment, the ammonium nitrate produced in step (6) may be returned to step (4) or to step (5) (ie step (5)(a)(ii)), or, more preferably, to both step (4) and step (5). In this way, all of the ammonium nitrate produced in step (6) would be returned to the process and an amount of additional ammonium nitrate (from step (3)) would also have to be added to one or both of step (4) and step (5). The process of this embodiment does not produce excess ammonium nitrate and thus the process does not necessarily have to be appended to an ammonium nitrate plant. The process of this embodiment actually requires a net input of ammonium nitrate, albeit at a reduced level, and thus the economics of the process are not dependent upon finding suitable markets for excess ammonium nitrate or being attached to an existing ammonium nitrate plant. Indeed, steps (1) to (3) of the process of this embodiment may take place at a location away from the site of steps (4) to (6), with steps (1) to (3) being equivalent to providing a source of ammonium nitrate to the site of process steps (4) to (6).

Thus, in the process of this embodiment, the process of the first aspect of the invention further comprises:
(9) returning the ammonium nitrate produced in step (6) to one or both of steps (4) and (5). Preferably, the ammonium nitrate produced in step (6) is returned to step (4) and step (5).

In this embodiment, step (5) comprises step (5)(a)(ii). Suitably, the compound containing the second metal is Al(OH)₃.

With the above description in mind, it will be seen that one preferred embodiment of the invention provides a method that includes preparing a nitrate containing the first metal by reacting a compound containing the first metal with nitric acid from step (1), providing an hydroxide containing the second metal, mixing the nitrate containing the first metal with the hydroxide containing the second metal and ammonium hydroxide to form the LDH and ammonium nitrate and separating the LDH and ammonium nitrate into a liquid phase containing the ammonium nitrate and a solid phase containing the LDH. More preferably, in this embodiment, the ammonium hydroxide is supplied from step (2) and the liquid phase containing ammonium nitrate is returned to step (3) or (4) or recovered for storage or sale. In another preferred embodiment, the first metal is magnesium and magnesium nitrate is formed by reacting one or more of magnesite, magnesia or magnesium hydroxide with nitric acid, and the second metal is aluminium and the hydroxide containing aluminium is NaAl(OH)₄, and the step of forming the LDH and ammonium nitrate also forms sodium nitrate and the method further includes treating the liquid phase to remove sodium nitrate therefrom. In another embodiment, the first metal is magnesium and magnesium nitrate is formed by reacting one or more of magnesite, magnesia or magnesium hydroxide with nitric acid, and the second metal is aluminium and the hydroxide containing aluminium is Al(OH)₃.

In another preferred embodiment, the method includes preparing a nitrate containing the first metal by reacting the compound containing the first metal with ammonium nitrate, preparing a nitrate containing the second metal by reacting a compound containing the second metal with nitric acid, mixing the nitrate containing the first metal with the nitrate containing the second metal and ammonium hydroxide to form the LDH and ammonium nitrate and separating the LDH and ammonium nitrate into a liquid phase containing ammonium nitrate and a solid phase containing LDH. Even more preferably, the compound containing the first metal is calcined magnesia and the step of forming the nitrate containing the first metal comprises reacting the calcined magnesia with ammonium nitrate to form magnesium nitrate and ammonium hydroxide and the compound containing the second metal is sodium aluminate or aluminium trihydroxide.

In another embodiment, the method includes the steps of preparing a nitrate containing the first metal by contacting the compound containing the first metal with ammonium nitrate, preparing a nitrate containing the second metal by contacting the compound containing the second metal with ammonium nitrate, mixing the nitrate containing the first metal with the nitrate containing the second metal and ammonium hydroxide to form the LDH and ammonium nitrate, separating the LDH and ammonium nitrate into a liquid phase containing ammonium nitrate and a solid phase containing LDH and recycling the ammonium nitrate to step (2) or to the steps of preparing the nitrate of the first metal and/or preparing the nitrate of the second metal.

The recovered LDH containing nitrate as an interlayer anion may be used as a slow release fertiliser in accordance with the teachings of an co-pending International patent application no. PCT/AU01/00026. It may also be ion-exchanged with sulphate and/or phosphate ions. This may produce a fertiliser for supplying sulphate and/or phosphate to the soil. This is preferably achieved by providing sulphuric acid and/or phosphoric acid and contacting with ammonia to make ammonium sulphate and/or ammonium phosphate. The ammonium sulphate and/or ammonium phosphate is then contacted with the LDH to exchange the nitrate interlayer anions. The by-product is ammonium nitrate. The LDH may also be used in other applications. For example, it could be used in the treatment of phosphatic wastes, such as chicken manure from chicken batteries.

The present invention also relates to an integrated plant for producing ammonium nitrate and LDH containing nitrate as interlayer anions.

In a second aspect, the present invention provides an integrated plant for producing ammonium nitrate and LDH containing nitrate as an interlayer anion including an ammonium nitrate plant for producing ammonium nitrate from nitric acid and ammonia, a first reactor for producing the IDH by mixing a compound containing a first metal, a compound containing a second metal, ammonium hydroxide and one or both of nitric acid or ammonium nitrate, wherein at least part of one or more of the nitric acid, ammonium nitrate and ammonium hydroxide are provided from the ammonium nitrate plant and separation means for separating the LDH material and ammonium nitrate formed in the first reactor into a liquid phase containing ammonium nitrate and a solid phase containing LDH material.

The plant may further include a second reactor for mixing a compound containing the first metal with either nitric acid or ammonium nitrate to produce a nitrate containing the first metal and first transfer means for transferring the nitrate containing the first metal from the second reactor to the first reactor. More preferably, in this embodiment, the plant further includes nitric acid transfer means for transferring nitric acid from the ammonium nitrate plant to the second reactor such that the compound containing the first metal and nitric acid react in the second reactor to form the nitrate containing the first metal.

In another embodiment, the plant may further include a third reactor for mixing a compound containing the second metal with nitric acid or ammonium nitrate to produce a nitrate containing the second metal and second transfer means for transferring the nitrate containing the second metal from the third reactor to the first reactor. More preferably, in this embodiment, the plant further includes nitric acid transfer means for transferring nitric acid from the ammonium nitrate plant to the third reactor such that the compound containing the second metal and nitric acid react to form the nitrate containing the second metal.

The plant may also include ammonium nitrate transfer means for transferring ammonium nitrate to the second reactor such that the ammonium nitrate reacts with the compound containing the first metal to form the nitrate containing the first metal and transfer means to transfer the nitrate containing the first metal from the second reactor to the first reactor.

In embodiments where reaction of the compound containing the first metal with the ammonium nitrate also forms ammonium hydroxide, the plant may further include ammonium hydroxide separation means for separating ammonium hydroxide from the nitrate containing the first metal and ammonium hydroxide transfer means for transferring the ammonium hydroxide to the ammonium hydroxide plant. Alternatively, the thus-formed ammonium hydroxide may be transferred along with the nitrate containing the first metal to the first reactor.

It is preferred that the ammonium nitrate formed in the first reactor is recovered for sale. To this end, the plant preferably includes ammonium nitrate transfer means for transferring ammonium nitrate formed in the first reactor to the ammonium nitrate plant or to an ammonium nitrate storage facility. Alternatively or additionally, the plant may include ammonium nitrate transfer means for transferring ammonium nitrate from the separation means to the second reactor or the third reactor.

### BRIEF DESCRIPTION OF THE DRAWINGS

Preferred embodiments of the present invention will now be described with reference to the accompanying drawings in which:

FIG. 1 shows a process flow sheet of one embodiment of a process in accordance with the present invention:

FIG. 2 shows a process flow sheet of another embodiment of a process in accordance with the present invention;

FIG. 3 shows a modified version of the process shown in FIG. 2;

FIG. 4 shows a process flow sheet of a further embodiment of a process in accordance with the present invention:

FIG. 5 shows a process flow sheet of a particular aspect of the process of FIG. 4 or 5 in accordance with the present invention; and

FIG. 6 shows a hypothetical flowsheet of a process in accordance with a further embodiment of the invention.

It will be understood that the following description of the preferred embodiments are provided to illustrate the invention and that the invention should not be considered to be limited to the embodiments described.

### DETAILED DESCRIPTION OF THE EMBODIMENTS

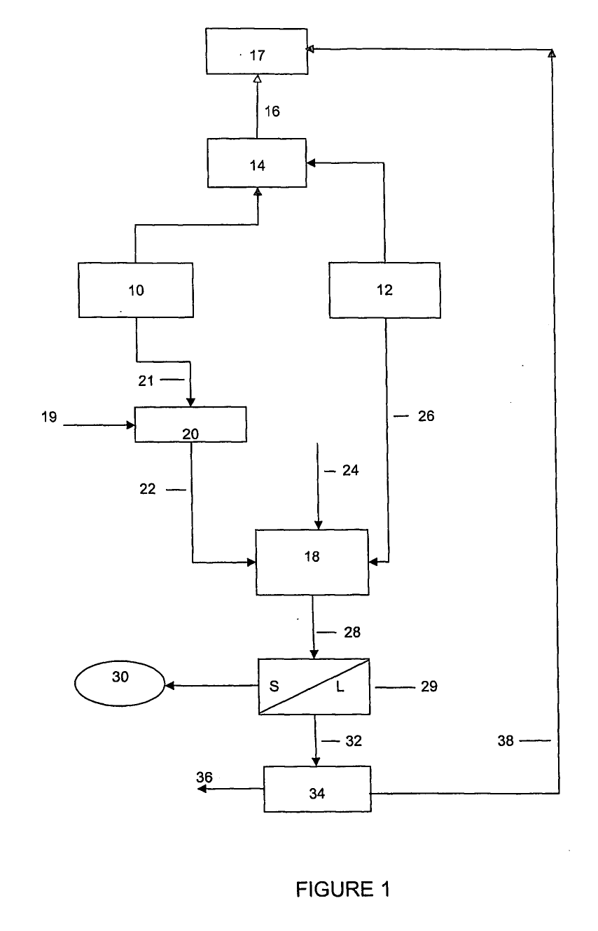

The schematic process flow sheets shown in FIGS. 1 to 3 relate to the manufacture of hydrotalcite or layered double hydroxide compounds, particularly for use as slow release fertiliser materials. In particular, in the embodiments shown in FIGS. 1 to 3, hydrotalcite-like compounds that contain nitrate, phosphate or sulphate in the interlayer spaces are produced by directly synthesising hydrotalcite containing nitrate as the interlayer anion (NO₃—HT) and subsequently converting a portion of NO₃—HT into hydrotalcite containing phosphate as the interlayer anion (PO₄—HT) and hydrotalcite containing sulphate as an interlayer anion (SO₄—HT). Furthermore, any anion that can be exchanged with nitrate, such as silicate or borate, can be substituted into the interlayer spaces by ion exchange.

Two alternate synthesis pathways are proposed for the direct synthesis of NO₃—HT:
2Mg(NO₃)₂+NaAl(OH)₄+2NHOH→Mg₂Al(OH)₆.NO₃+2NH₄NO₃+NaNO₃ (a)
2Mg(NO₃)₂+Al(NO)₃+6NH₄OH→Mg₂Al(OH)₆.NO₃+6NH₄NO₃ (b)

Either of these synthesis routes could be incorporated into an ammonium nitrate manufacturing plant, with the residue or by-product from the hydrotalcite plant (ammonium nitrate) rejoining the primary production stream.

FIG. 1 shows a schematic process flow sheet that illustrates the incorporation of pathway (a) into an ammonium nitrate plant. In FIG. 1, a conventional ammonium nitrate plant includes a nitric acid plant 10 and an ammonia plant 12. Nitric acid from nitric acid plant 10 and ammonia from ammonia plant 12 are mixed and reacted in reactor 14 to produce ammonium nitrate. Ammonium nitrate is recovered via stream 16 from reactor 14 and sent to ammonium nitrate storage facility 17.

The process flow sheet shown in FIG. 1 also includes an NO₃—HT reactor 18. In order to operate this reactor 18, magnesite (MgCO₃) 19 is reacted in magnesite reactor 20 with nitric acid from line 21 from nitric acid plant 10. This converts the magnesite into magnesium nitrate, which leaves magnesite reactor 20 via line 22.

Sodium aluminate is supplied via line 24 into NO₃—HT plant, where it is mixed with magnesium nitrate from line 22 and ammonium hydroxide, which is supplied via line 26 from ammonia plant 12. The sodium aluminate may be provided from a pregnant Bayer liquor. The Bayer liquor may be obtained from a bauxite digestion plant. If the Bayer liquor contains dissolved iron, the dissolved iron could become incorporated into a pyroaurite LDH compound which would slightly reduce the anion exchange capacity of the IDH compound but otherwise have no deleterious effects.

The product from the NO₃—HT plant includes NO₃—HT, ammonium nitrate and sodium nitrate. In the embodiment shown in FIG. 1, a mixed stream containing these components leaves NO₃—HT plant via line 28. This stream is separated in solid-liquid separator 29 into a solids stream containing an NO₃—HT product 30. The solids stream may be washed one or more times to remove residual ammonium nitrate. However, if the NO₃—HT product is to be used as a fertiliser, benefits to plant or crop growth may arise by not washing the solid product. In this way, residual ammonium nitrate adhering to the NO₃—HT particles is available for rapid release to the soil following application of the fertiliser to the soil, followed by slow release of the interlayer nitrate. The NO₃—HT product may be dried, if desired.

The solid-liquid separator may be of any type known to be suitable bt the person skilled in the art.

A liquid stream containing ammonium nitrate and sodium nitrate is separated from the NO₃—HT product via line 32 and is passed to crystalliser 34, where sodium nitrate 36 is crystallised out. Ammonium nitrate leaves crystalliser via line 38 and is recovered as an ammonium nitrate product, such as by sending to ammonium nitrate storage 17.

The overall chemical reaction for processes within the modified ammonium nitrate plant is:
2MgCO₃+Al(OH)₃+4HNO₃+NaOH+2NH₄OH═Mg₂Al(OH)₆.NO₃₊₂NH₄NO₃+NaNO₃+2CO₂+2H₂O

If the basic reaction for ammonium nitrate manufacture is written as:
2HNO₃+2NH₄OH=2NH₄NO₃+2H₂O

then 12.5 kmoles of HNO₃ and 12.5 kmoles of NH₄OH are required to produce 1 tonne of ammonium nitrate.

Therefore, the additional materials required to produce 1 tonne of ammonium nitrate in the modified plant become:

1.25 tonne of magnesite (84% MgCO₃)

488 kg of aluminium trihydrate

1.04 tonne of solid caustic soda

12.5 kmoles of nitric acid

resulting in production of 1.5 tonne of NO₃—HT, along with 530 kg of by-product NaNO₃.

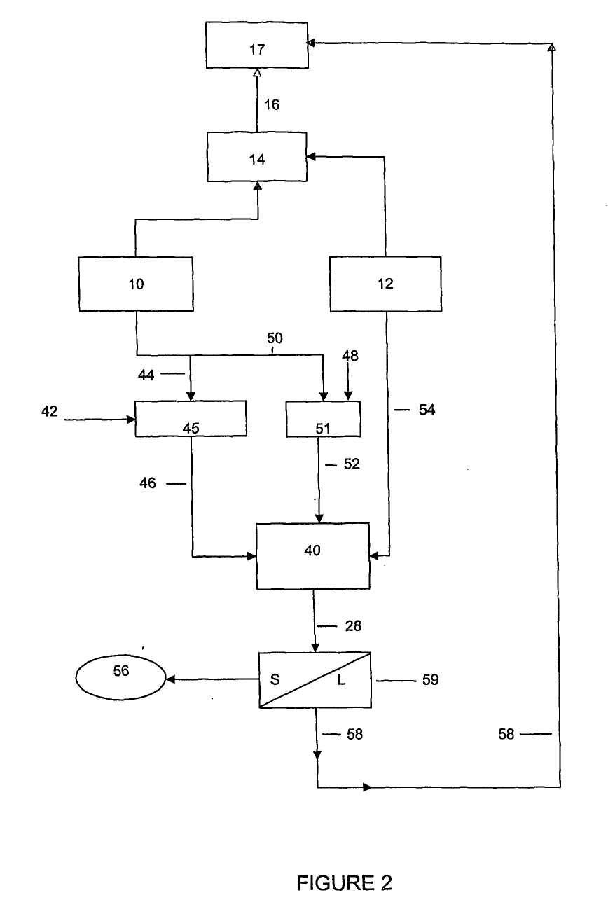

FIG. 2 shows a schematic process flow sheet for the synthesis of NO₃—HT using aluminium trihydrate and magnesite as additional feedstock materials. In the process flow sheet of FIG. 2, a conventional ammonium nitrate plant is provided and this plant is denoted by the same references numerals as those used in FIG. 1.

The process flow sheet FIG. 2 also includes an NO₃—HT reactor 40. Magnesite 42 is mixed with nitric acid that is supplied from nitric acid plant 10 via line 44. This produces magnesium nitrate in reactor 45, which is fed to NO₃—HT reactor via line 46. Aluminium trihydrate 48 is reacted with nitric acid from nitric acid plant via line 50. This produces aluminium nitrate in reactor 51, with the aluminium nitrate being supplied via line 52 to NO₃—HT reactor 40.

Ammonium hydroxide is supplied from ammonia plant 12 via line 54 to the NO₃—HT reactor 40. The reaction inside NO₃—HT reactor 40 results in the production of a mixture of NO₃—HT and a solution containing ammonium nitrate. This mixture leaves the reactor 40 by line 28. It is separated in solid-liquid separator 59 into a solids stream containing NO₃—HT product 56 and a liquid stream containing ammonium nitrate, which is recovered via line 58. It will be appreciated that ammonium nitrate and NO₃—HT product may be separated by one or more solid/liquid separation steps, such as shown at 59.

The overall chemical reaction for this synthesis route is:
2MgCO₃+Al(OH)₃+7HNO₃+6NH₄OH═Mg₂Al(OH)₆.NO₃+6NH₄NO₃+2CO₂+5H₂O

Writing the basic reaction for ammonium nitrate manufacture as:
6HNO₃+6NH₄H=6NH₄NO₃+6H₂O

indicating that 12.5 kmoles of HNO₃ and 12.5 kmoles of NH₄OH are required for the production of 1 tonne of ammonium nitrate.

The additional materials needed to manufacture 1 tonne of ammonium nitrate in the modified plant are:
416 kg of magnesite (84% MgCO₃)
162 kg of aluminium trihydrate
2.08 kmoles of HNO₃
leading to the production of 0.5 tonnes of NO₃—HT.

Decisions relating to which synthesis pathway to follow would be based on a range of criteria including:
the balance between NO3-HT and ammonium nitrate required
the relative costs of digestion of aluminium trihydrate in nitric acid and caustic soda
the value of sodium nitrate residue vis a vis crystallisation costs
the relative values of ammonium nitrate and sodium nitrate

Subsequent to the production of NO₃—HT, ammonium nitrate plant resources can be further used to produce PO₄—HT and SO₄—HT by introduction of phosphoric and sulphuric acids to react with plant ammonia to form solutions of ammonium phosphate and ammonium sulphate. These latter solutions would then be used to exchange nitrate in NO₃—HT with PO₄ and SO₄, with the only residue, ammonium nitrate, being returned to the primary production stream.

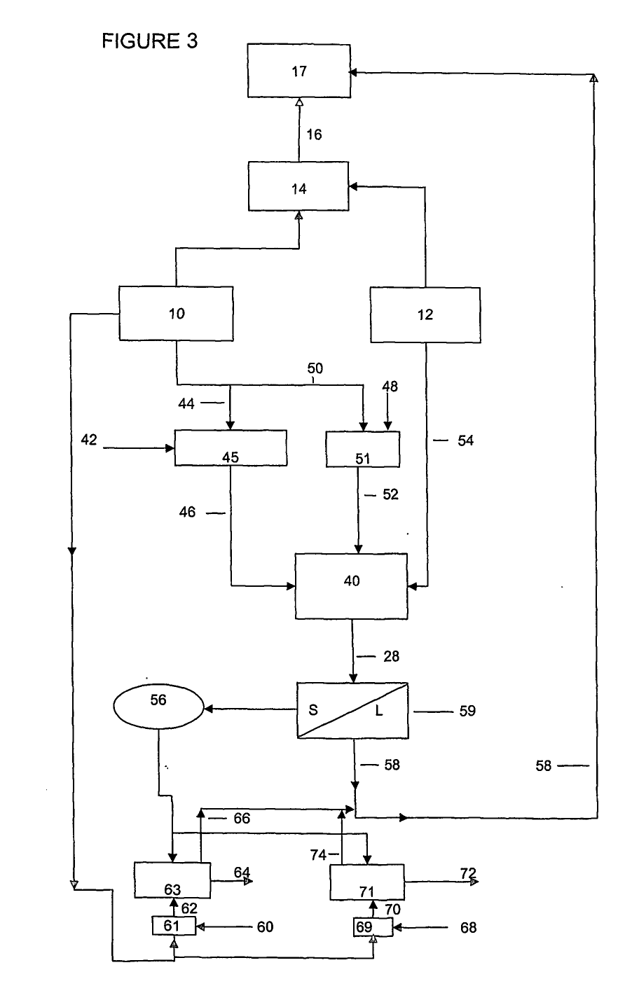

FIG. 3 shows possible modifications to the flow sheet shown in FIG. 2 in order to produce PO₄—HT product and SO₄—HT product. Where the features of FIG. 3 are identical to those of FIG. 2, they are given the same reference numerals as used in FIG. 2. The process flow sheet of FIG. 3 further includes mixing sulphuric acid 60 with ammonia in reactor 61 to form ammonium sulphate 62. This is then ion exchanged with the NO₃—HT product in reactor 63 to form SO₄—HT product 64 and ammonium nitrate 66. Similarly, phosphoric acid 68 can be mixed in reactor 69 with ammonia from ammonium plant 12 to form a solution of ammonium phosphate 70. This solution is then used to ion exchange the NO₃—HT product in reactor 71 to form SO₄—HT product 72 and ammonium nitrate 74.

Examples of the above described processes are as follows:

### EXAMPLE 1

250 mL of 1.5M Mg(NO₃)₂ solution obtained from the digestion of magnesite with nitric acid was combined with 250 mL of 0.75M NaAl(OH)₄ (diluted commercial sodium aluminate) over a 30 minute period using peristaltic pumps. The pH was maintained at 9.5-9.6 by dropwise additional of concentrated aqueous ammonia. The resulting slurry was aged at 80° C. for 8 hours, cooled, and washed with water to remove the bulk of free ammonium and sodium nitrates. The filter cake was dried at 80° C. to yield about 50 g of NO₃—HT from which 330 me NO₃/100 g HT and 50 me NO₃/100 g HT could be extracted with 2M KCl and H₂O respectively.

### EXAMPLE 2

250 mL of 2.85M Mg(NO₃)₂ solution obtained from digestion of magnesite in nitric acid was combined with 250 mL of 1.425M Al(NO₃)₃ solution from digestion of aluminium trihydrate in nitric acid over a 30 minute period using peristaltic pumps. The pH was maintained at 9.5-9.6 by dropwise additional of concentrated aqueous ammonia The resulting slurry was heated to 80° C. for 8 hours, cooled, and washed with water. This product contained 319 me NO₃/100 g HT and 54 me NO₃/100 g HT extracted with 2M KCl and H₂O respectively.

### EXAMPLE 3

77 ml of 2.61M Mg(NO₃)₂ obtained by digesting magnesite in nitric acid was combined with 45 ml of 2.2M Al(NO₃)₃ produced from digestion of aluminium tri-hydrate with nitric acid, and the volume made up to 200 ml. Thus this mixed nitrate solution was 1.0M with respect to Mg and 0.5M with respect to Al. Over a 2 minute period the mixed nitrate solution was pumped into 100 ml of concentrated ammonia solution with vigorous stirring. The resulting slurry was aged at 80° C. for 8 hours, cooled, washed with distilled water, and dried at 80° C. to yield 22 g of product from which 352 me NO₃/100 g HT and 68 me NO₃/100 g HT could be extracted with 2M KCl and H₂O respectively.

Examples 4 and 5 demonstrate the ion exchange of nitrate interlayer anions with phosphate and sulphate ions, respectively.

### EXAMPLE 4

Ten mL of 0.25M di-ammonium phosphate solution was added to 6.2 g of freshly prepared NO₃—HT filter cake (72% w/w moisture content) and intermittently agitated on a vortex stirrer over a one hour period. After centrifugation, the concentrations of phosphate and nitrate in the supernatant solution were 14 ppm P and 4370 ppm N, demonstrating effective replacement of nitrate in the HT by phosphate.

### EXAMPLE 5

Ten mL of 0.25M ammonium sulphate solution was added to 8.8 of freshly prepared NO₃—HT filter cake (72% w/w moisture content) and intermittently agitated on a vortex stirrer over a one hour period. After configuration, the concentrations of sulphate and nitrate in the supernatant solution were 20 ppm S and 3910 ppm N, demonstrating effective replacement of nitrate in the HT by sulphate.

Examples 6 and 7 demonstrate that the rapid production process described in Example 3, and the conversion of NO₃—HT to PO₄—HT described in Example 4 is readily up-scaled.

### EXAMPLE 6

259 L of 3.09 M Mg(NO₃)₂ solution obtained from the digestion of magnesite with nitric acid was combined with 288 L of 1.39 M Al(NO₃)₂ which was obtained from the digestion of aluminium tri-hydrate with nitric acid. The solutions were completely mixed and then 253 L of deionised water was added to bring the total solution volume to 800 L. This resulted in a mixed nitrate solution solution that was 1.0M in Mg and 0.5 M in Al.

400 L of aqueous ammonia (25% w/w NH₄OH) was added to a stirred 1200 L butyl rubber lined tank. The mixed nitrate solution was then pumped into the stirred tank until the pH of the resultant slurry dropped to 9.5-9.6. The resulting slurry was aged at 80° C. for 8 hours and allowed to cool overnight.

The slurry was then filtered on a filter press and washed with water to remove the bulk of free ammonium nitrates. The filter cake was extruded through a 5 mm orifice to produce long spaghetti shaped noodle. These noodles were then dried at 80° C. in a fan forced oven overnight to yield about 100 kg of NO₃—HT from which 337 me NO₃/100 g HT and 72 me NO₃/100 g HT could be extracted with 2M KCl and H₂O respectively.

### EXAMPLE 7

492 L of 1.93 M Mg(NO₃)₂ solution obtained from the digestion of magnesite with nitric acid was combined with 206 L of 2.24 M Al(NO₃)₂ which was obtained from the digestion of aluminium tri-hydrate with nitric acid. The solutions were completely mixed and then 102 L of deionised water was added to bring the total solution volume to 800 L. This resulted in a mixed nitrate solution solution that was 1.2 M in Mg and 0.6 M in Al.

400 L of aqueous ammonia (25% w/w NH4OH) was added to a stirred 1200 L butyl rubber lined tank. The mixed nitrate solution was then pumped into the stirred tank until the pH of the resultant slurry dropped to 9.5-9.6. Next, 40 kg of dry solid mono-ammonium phosphate solid (50-52% P₂O₅) was added to the mix. The resultant slurry was heated to 80° C. and stirred for 4 hours.

The slurry was then filtered on a filter press and washed with water to remove the bulk of free ammonium nitrates. The filter cake was extruded through a 5 mm orifice to produce long spaghetti shaped noodle. These noodles were then dried at 80° C. in a fan forced oven overnight to yield about 100 kg of PO₄-HT with a P content of 7.2%.

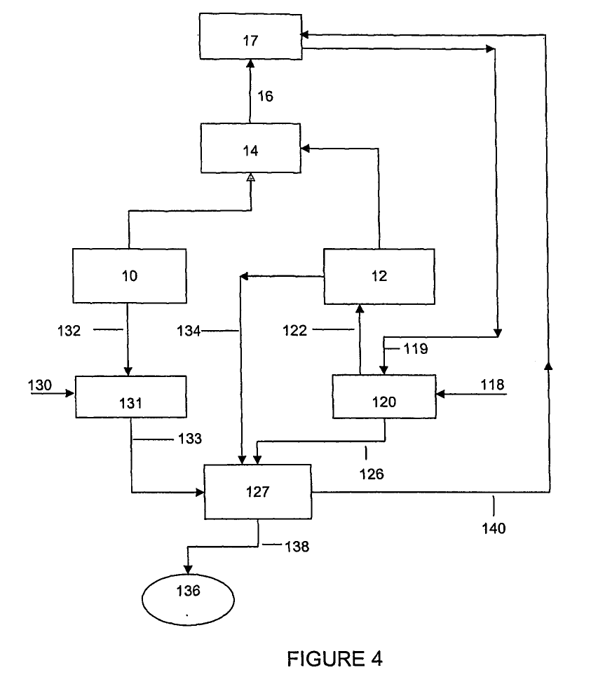

FIG. 4 shows an alternative embodiment of the present invention that involves at least partial recycle of ammonium nitrate produced in step (6).

FIG. 4 shows a schematic process flow chart that incorporates the production of NO₃—HT into an ammonium nitrate plant. Nitric acid from a nitric acid plant 10 and ammonia from an ammonia plant 12 are mixed and reacted in reactor 14 to produce ammonium nitrate. Ammonium nitrate is recovered via stream 16 from reactor 14 and sent to ammonium nitrate storage facility 17.

The process flow sheet shown in FIG. 4 also includes a NO₃—HT plant. In order to operate this plant, calcined magnesite (MgO) 118 is reacted with ammonium nitrate 119 in magnesium oxide reactor 120. This converts the magnesium oxide to magnesium nitrate and ammonia. The ammonia is returned to the ammonia plant 12 via line 122. Magnesium nitrate from the magnesium oxide reactor 120 is sent to the NO₃—HT reactor 127 via line 126. Alternatively, the ammonium hydroxide may be sent with the magnesium nitrate to the NO₃—HT reactor 127.

Aluminium trihydrate 130 is reacted in reactor 131 with nitric acid supplied via line 132 from the nitric acid plant 10, to produce aluminium nitrate. The aluminium nitrate is sent to the NO₃—HT reactor 127 through line 133. Ammonia from the ammonia plant 12 is supplied to the NO₃—HT reactor 127 via line 134. The reaction inside the NO₃—HT reactor 127 results in the production of NO₃—HT product 136, which is recovered via line 138, and of ammonium nitrate which is sent to the ammonium nitrate plant via line 140. It will be appreciated that ammonium nitrate and NO₃—HT product may be separated by one or more solid/liquid separation steps (not shown).

Examples of the process of digesting magnesia with ammonium nitrate to produce magnesium nitrate and ammonia are described in Examples 8 and 9.

### EXAMPLE 8

Magnesia produced from Kunwarara magnesite by calcining at 750-900° C. was leached batch-wise in an un-baffled glass beaker. Agitation was achieved with a propeller driven by an overhead stirrer motor. The temperature was controlled with a hotplate. The operating conditions were as follows:

Size of magnesia: −45 μm

Leachant solution: 28% w.w NH₄NO₃

Leaching temperature: 85° C.

Leaching time: 7.5 hours.

On leaching, 97.7% of the magnesium contained in the feed was extracted.

### EXAMPLE 9

Magnesia produced from Kunwarara magnesite by calcining at 750-900° C. was leached continuously in a two stage system. The first stage was conducted in a vented 1000 L baffled rubber-lined vessel. Heating of the contents was achieved by indirect steam heating. Agitation was achieved with a propeller driven by an overhead stirrer motor. The operating conditions were as follows:

Size of magnesia: −45 μm

Leachant solution: 18% w/w NH₄NO₃

Leachant feed rate: 200 μL/h

Magnesia feed rate: 14 kg/h

Stoichiometric ratio of leachant to magnesia: 1.11

Leaching temperature: 90° C.

Leaching time: 5.0 hours.

Extractions of Mg from this vessel were generally in the range 45-48% w/w. The slurry from this vessel was then fed to a 20-stage bubble cap stripper column. This column used indirect steam heating to heat the slurry in the bottom of the column to boiling point which resulted in a gas flow up the column which drove off the ammonia. The column operated under the following conditions:

Average temperature in bubble cap stages: 108° C.

Average temperature in column sump: 118° C.

Average pressure in column sump: 12 kPa

Average pressure in column top: 3 kPa

On leaching, 97.2% of the magnesium contained in the feed was extracted.

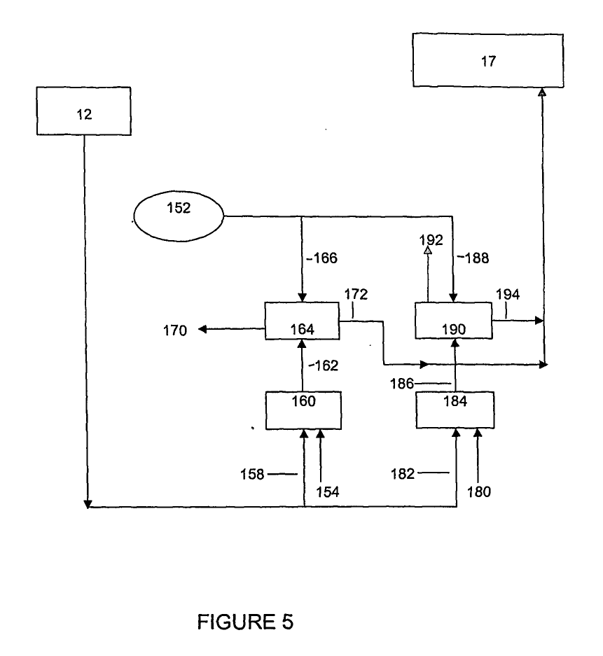

FIG. 5 schematically illustrates that portion of the process whereby NO₃—HT product 152 (as made in accordance with the present invention) can be reacted with ammonium sulphate and ammonium phosphate to form SO₄—HT and PO₄—HT, respectively, with the residual ammonium nitrate being returned to ammonium nitrate storage. In particular, sulphuric acid 154 is reacted in reactor 160 with ammonia 158 from ammonia plant 12 to form ammonium sulphate. The ammonium sulphate is transferred via line 162 to contactor 164, where it is contacted with NO₃—HT from line 166 to form SO₄—HT 170. Similarly, phosphoric acid 180 is reacted with ammonia 182 from ammonia plant 12 in reactor 184 to form ammonium phosphate 186. NO₃—HT from line 188 is contacted with ammonium phosphate 186 in contactor 190 to form PO₄—HT 192 and residual ammonium nitrate 194, which is returned to ammonium nitrate storage 17.

It has further been found that an LDH material containing CO₃ in the interlayers (CO₃—HT) can be produced from NO₃—HT product by bubbling CO₂ through the NO₃—HT slurry. Though of limited agricultural use, CO₃—HT is used in a wide range of industrial applications.

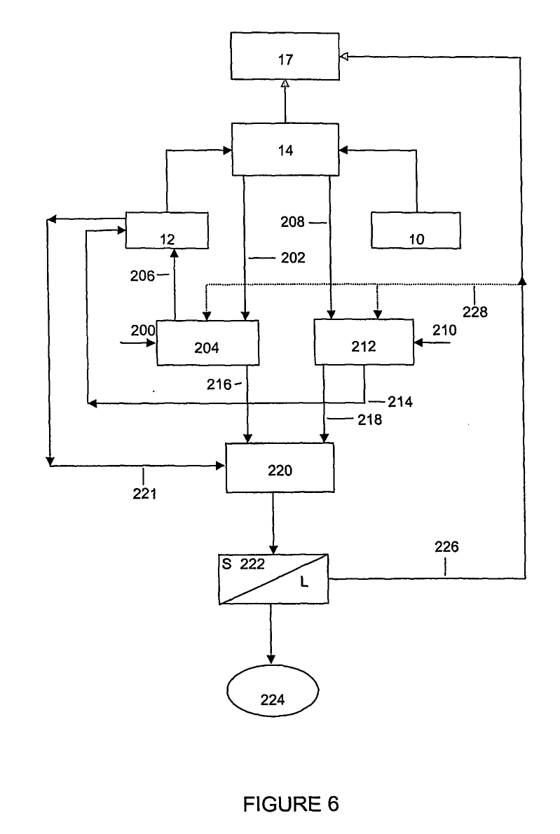

FIG. 6 shows a flowsheet of another embodiment of the present invention. In the process of FIG. 6, step (4) of the process forms a nitrate of the first metal by contacting a compound containing the first metal with ammonium nitrate and step (5) of the process involves the step (5)(a)(ii). The flowsheet of FIG. 6 shows recycle of the ammonium nitrate produced in the hydrotalcite formation step back to the steps for making magnesium nitrate and aluminium nitrate. Due to the mass balance requirements of this embodiment of the invention, all of the ammonium nitrate formed in the hydrotalcite production step can be recycled and further ammonium nitrate is also required for make-up. The recycling of the ammonium nitrate means that the process of FIG. 6 does not have an ammonium nitrate product stream. Thus, the economics of the process do not require a viable market for ammonium nitrate and consequently the flowsheet of FIG. 6 does not have to be tied to an ammonium nitrate plant. Further, the recycle of the ammonium nitrate formed in the hydrotalcite production step also reduces the amount of feedstock reagents required in the process.

Turning now to FIG. 6, the process of FIG. 6 involves providing ammonia from a source of ammonia 12 and nitric acid from a source of nitric acid 10. The source of nitric acid may be a nitric acid plant or a nitric acid storage facility. The source of ammonia may be an ammonia plant or an ammonia storage facility.

The nitric acid and ammonia are contacted under appropriate conditions in reactor 14 to produce ammonium nitrate. The ammonium nitrate is subsequently stored in ammonium nitrate storage facility 17. As an alternative, ammonium nitrate may be supplied from a separate source.

Calcined magnesia 200 is mixed with ammonium nitrate 202 in reactor 204 to produce magnesium nitrate and ammonia The ammonia may be returned to ammonia source 10 via line 206. Ammonium nitrate 208 from reactor 14 is also mixed with aluminium trihydroxide 210 in reactor 212 to form aluminium nitrate and ammonium hydroxide. The ammonium hydroxide may be returned to ammonia source 10 via line 214.

Subsequently, the magnesium nitrate 216, aluminium nitrate 218 and ammonium hydroxide 221 are mixed in reactor 220 to produce hydrotalcite having nitrate as interlayer anions and ammonium nitrate. Following suitable liquid/solid separation steps 222, the hydrotalcite is separated from the ammonium nitrate. The hydrotalcite 224 may be further treated, for example, as described with reference to FIG. 3. The ammonium nitrate 226 is recycled back to ammonium storage facility 17 or to be mixed with further calcined magnesite and aluminium trihydroxide (see dotted line 228). Due to the mass balance requirements of the process (as outlined below), some make-up ammonium nitrate will be required, although the amount of ammonium nitrate required is significantly reduced by the recycling of ammonium nitrate.

The steps involved in this process are as follows:

(a) produce seven moles of ammonium nitrate by reaction of ammonia and nitric acid;

(b) use four moles of ammonium nitrate to react with two moles of calcined magnesia to produce two moles of magnesium nitrate and ammonia;

(c) use three moles of ammonium nitrate to react with one mole of aluminium trihydroxide to form one mole of aluminium nitrate and ammonia;

(d) mix the magnesium nitrate, aluminium nitrate and appropriate amount of ammonia to form hydrotalcite having nitrate interlayer anions and six moles of ammonium nitrate;

(e) recycle the six moles of ammonium nitrate to steps (b) and (c) above; and

(f) produce one mole of ammonium nitrate to provide the required amounts of ammonium nitrate for steps (b) and (c).

In continuous operation, the process of FIG. 6 effectively involves steps (b) to (f) above.

The process of FIG. 6 requires a reduced production of ammonium nitrate due to the closed loop recycle of ammonium nitrate. The process of FIG. 6 can also be stand-alone from an ammonium nitrate plant as ammonium nitrate is not a product of the process. It is, of course, possible that the process of FIG. 6 could also be integrated into an ammonium nitrate plant.

The process of FIG. 6 is presently a hypothetical process flowsheet because it is currently difficult (if not impossible) to react the aluminium trihydroxide with ammonium nitrate to form aluminium nitrate. Practical implementation of the hypothetical flowsheet of FIG. 6 awaits development of appropriate process chemistry and/or appropriate catalysts to achieve the step of producing aluminium nitrate.

Those skilled in the art will appreciate that the invention described herein may be susceptible to variations and modifications other than those specifically described. It will be understood that the present invention encompasses all such variations and modifications that fall within its spirit and scope.

1-30. (canceled)

31. A method for the manufacture of ammonium nitrate and LDH containing nitrate as an interlayer anion, the method including the steps of:
(1) providing a source of nitric acid
(2) providing a source of ammonia;
(3) reacting ammonia with nitric acid to produce ammonium nitrate;
(4) preparing a nitrate containing a first metal by reacting a compound containing the first metal with nitric acid or ammonium nitrate;
(5) either:
(a) preparing a nitrate containing a second metal by:
(i) contacting a compound containing the second metal with nitric acid; or
(ii) contacting a compound containing the second metal with ammonium nitrate; or
(b) providing a compound containing the second metal; and
(6) mixing the nitrate containing the first metal from step (4) with the nitrate containing the second metal or the compound containing the second metal from step (5) and ammonium hydroxide to form the LDH containing nitrate as an interlayer anion and ammonium nitrate.

32. A method as claimed in claim 31 further including the step of:
(7) recovering the LDH and the ammonium nitrate from step (6).

33. A method as claimed in claim 31 wherein the source of nitric acid comprises a nitric acid plant or a nitric acid storage facility.

34. A method as claimed in claim 31 wherein the source of ammonia is an ammonium plant for the production of ammonia or an ammonia storage facility.

35. A method as claimed in claim 31 wherein steps (1), (2) and (3) comprise process steps for producing ammonium nitrate in an ammonium nitrate plant.

36. A method as claimed in claim 31 including preparing a nitrate containing the first metal by reacting a compound containing the first metal with nitric acid from step (1), providing an hydroxide containing the second metal, mixing the nitrate containing the first metal with the hydroxide containing the second metal and ammonium hydroxide to form the LDH and ammonium nitrate and separating the LDH and ammonium nitrate into a liquid phase containing the ammonium nitrate and a solid phase containing the LDH.

37. A method as claimed in claim 36 wherein the ammonium hydroxide is supplied from step (2) and the liquid phase containing ammonium nitrate is returned to step (3) or recovered for storage or sale.

38. A method as claimed in claim 36 wherein the first metal is magnesium and magnesium nitrate is formed by reacting one or more of magnesite, magnesia or magnesium hydroxide with nitric acid, and the second metal is aluminium and the hydroxide containing aluminium is NaAl(OH)₄, and the step of forming the LDH and ammonium nitrate also forms sodium nitrate and the method further includes treating the liquid phase to remove sodium nitrate therefrom.

39. A method as claimed in claim 36 wherein the first metal is magnesium and magnesium nitrate is formed by reacting one or more of magnesite, magnesia or magnesium hydroxide with nitric acid, and the second metal is aluminium and the hydroxide containing aluminium is Al(OH)₃.

40. A method as claimed in claim 38 wherein the hydroxide containing aluminium is derived from bauxite.

41. A method as claimed in claim 31 including preparing a nitrate containing the first metal by reacting the compound containing the first metal with ammonium nitrate, preparing a nitrate containing the second metal by reacting a compound containing the second metal with nitric acid, mixing the nitrate containing the first metal with the nitrate containing the second metal and ammonium hydroxide to form the LDH and ammonium nitrate and separating the LDH and ammonium nitrate into a liquid phase containing ammonium nitrate and a solid phase containing LDH.

42. A method as claimed in claim 41 wherein the compound containing the first metal is calcined magnesia and the step of forming the nitrate containing the first metal comprises reacting the calcined magnesia with ammonium nitrate to form magnesium nitrate and ammonium hydroxide and the compound containing the second metal is sodium aluminate or aluminium trihydroxide.

43. A method as claimed in claim 31 including the steps of preparing a nitrate containing the first metal by contacting the compound containing the first metal with ammonium nitrate, preparing a nitrate containing the second metal by contacting the compound containing the second metal with ammonium nitrate, mixing the nitrate containing the first metal with the nitrate containing the second metal and ammonium hydroxide to form the LDH and ammonium nitrate, separating the LDH and ammonium nitrate into a liquid phase containing ammonium nitrate and a solid phase containing LDH and recycling the ammonium nitrate to step (2) or to the steps of preparing the nitrate of the first metal and/or preparing the nitrate of the second metal.

44. A method as claimed in claim 31 wherein step 5(b) comprises supplying sodium aluminate provided from a pregnant Bayer liquor from a bauxite digestion plant.

45. A method as claimed in claim 31 further including preparing the nitrate containing the first metal in step (4) by reacting the compound containing the first metal with ammonium nitrate.

46. A method as claimed in claim 45 wherein ammonium nitrate formed in step (6) is recycled to step (4) to produce more nitrate containing the first metal for LDH production.

47. A method as claimed in claim 45 wherein ammonia is also produced in step (4), and the ammonia is passed to step (6) or recycled to the source of ammonia in step (2).

48. A method as claimed in claim 31 wherein step (5) includes producing a nitrate containing the second metal by contacting a compound containing the second metal with ammonium nitrate and ammonium nitrate produced in step (6) is returned to step (5).

49. A method as claimed in claim 45 wherein step (5) includes producing a nitrate containing the second metal by contacting a compound containing the second metal with ammonium nitrate and ammonium nitrate produced in step (6) is returned to step (5) or returned to step (4) or returned to both step (4) and step (5).

50. A method as claimed in claim 31 wherein the fist metal is magnesium, the second metal is aluminium, the LDH is hydrotalcite and the hydrotalcite is formed by mixing aqueous solutions containing the first metal and the second metal and mixing with ammonium hydroxide to maintain a pH at about 9.5.

51. An integrated plant for producing ammonium nitrate and LDH containing nitrate as an interlayer anion including an ammonium nitrate plant for producing ammonium nitrate from nitric acid and ammonia, a first reactor for producing the LDH material by mixing a compound containing a first metal, a compound containing a second metal, ammonium hydroxide and one or both of nitric acid or ammonium nitrate, wherein at least part of one or more of the nitric acid, ammonium nitrate and ammonium hydroxide are provided from the ammonium nitrate plant and separation means for separating the LDH material and ammonium nitrate formed in the first reactor into a liquid phase containing ammonium nitrate and a solid phase containing LDH material.

52. A plant as claimed in claim 51 further including a second reactor for mixing a compound containing the first metal with either nitric acid or ammonium nitrate to produce a nitrate containing the first metal and first transfer means for transferring the nitrate containing the first metal from the second reactor to the first reactor.

53. A plant as claimed in claim 51 further including a third reactor for mixing a compound containing the second metal with nitric acid or ammonium nitrate to produce a nitrate containing the second metal and second transfer means for transferring the nitrate containing the second metal from the third reactor to the first reactor.

54. A plant as claimed in claim 53 further including nitric acid transfer means for transferring nitric acid from the ammonium nitrate plant to the second reactor such that the compound containing the first metal and nitric acid react in the second reactor to form the nitrate containing the first metal.

55. A plant as claimed in claim 53 further including nitric acid transfer means for transferring nitric acid from the ammonium nitrate plant to the third reactor such that the compound containing the second metal and nitric acid react to form the nitrate containing the second metal.

56. A plant as claimed in claim 52 further including ammonium nitrate transfer means for transferring ammonium nitrate to the second reactor such that the ammonium nitrate reacts with the compound containing the first metal to form the nitrate containing the first metal and transfer means to transfer the nitrate containing the first metal from the second reactor to the first reactor.

57. A plant as claimed in claim 56 wherein reaction of the compound containing the first metal with the ammonium nitrate also forms ammonium hydroxide and the plant further includes ammonium hydroxide separation means for separating ammonium hydroxide from the nitrate containing the first metal and ammonium hydroxide transfer means for transferring the ammonium hydroxide to the ammonium nitrate plant.

58. A plant as claimed in claim 53 further including ammonium nitrate transfer means for transferring ammonium nitrate to the third reactor such that the ammonium nitrate reacts with the compound containing the second metal to form the nitrate containing the second metal and transfer means to transfer the nitrate containing the second metal from the third reactor to the first reactor.

59. A plant as claimed in claim 58 wherein reaction of the compound containing the second metal with the ammonium nitrate also forms ammonium hydroxide and the plant further includes ammonium hydroxide separation means for separating ammonium hydroxide from the nitrate containing the second metal and ammonium hydroxide transfer means for transferring the ammonium hydroxide to the ammonium nitrate plant.

60. A plant as claimed in claim 51 further including ammonium nitrate transfer means for transferring ammonium nitrate formed in the first reactor to the ammonium nitrate plant or to ammonium nitrate storage.
